(19) United States
(12) Patent Application Publication
(10) Pub. No.: US 2024/0028083 A1
(43) Pub. Date: Jan. 25, 2024

(54) BRACKETS FOR MOUNTING ELECTRONIC COMPONENTS

(71) Applicant: Hewlett-Packard Development Company, L.P., Spring, TX (US)

(72) Inventors: Derek Kyle Joseph Kanas, Spring, TX (US); Chan Woo Park, Spring, TX (US); Tony Moon, Spring, TX (US)

(21) Appl. No.: 17/868,024

(22) Filed: Jul. 19, 2022

(51) Int. Cl. G06F 1/16; G06F 3/02

(52) U.S. Cl. CPC G06F 1/1662; G06F 3/0202

(57) ABSTRACT

In an example implementation according to aspects of the present disclosure, a component assembly for an electronic device includes an electronic component having a fastener surface defining an opening through which a head of a fastener passes completely through, and a bracket having a fastening surface defining a coupling recess into which a portion of a shank of the fastener can be releasably positioned to seat the bracket adjacent the electronic component.

### BACKGROUND

Computing devices have interfaces or input devices through which a user can provide input to the computing device. Examples of such input devices include a keyboard. When a keyboard on a laptop computer fails it is often times desirable to have it replaced.

### BRIEF DESCRIPTION OF THE DRAWINGS

FIGS. 1A and 1B illustrate a component assembly for an electronic device, according to an example;

FIGS. 2A-2F illustrate an electronic component mounting deck, according to an example;

FIGS. 3A-30 illustrate an electronic device, according to an example;

FIGS. 4A-4D illustrate a bracket, according to an example; and

FIGS. 5A-5C illustrate an electronic device, according to an example.

### DETAILED DESCRIPTION

Keyboards have one of the highest failure rates of computing components. A malfunctioning keyboard can include a plurality of functional parts. Replacing the failed laptop keyboard can include replacing many non-faulty parts or functional parts that are retained due to repair time constraints. Replacing functional parts of a malfunctioning or non-functional keyboard is wasteful in terms of both materials and money.

Examples disclosed herein relates to the serviceability of failed electronic components, such as a keyboard of a laptop computer. In some examples, the serviceability of failed electronic components allows for the replacement of a failed keyboard of a laptop computer without also having to replace the entire keyboard assembly that may include other associated components that are still viable. Seeing as a keyboard assembly of a laptop computer usually costs about four times that of the keyboard alone, having the ability to replace just the faulty keyboard in a timely and efficient manner would be advantageous in terms of both cost and repair time. The serviceability design of the present disclosure addresses this situation, allowing for cost savings and reductions in both waste and time in replacing the failed keyboard of a laptop computer.

Some keyboard assembly methods and components are not realistically serviceable and therefore the entire keyboard assembly (e.g., keyboard plus associated components) is replaced when the keyboard has failed. One reason for this lack of serviceability is the fasteners used to secure the keyboard in the keyboard assembly. Some keyboard assemblies use rivets or plastic heat stakes to secure the keyboard and so cannot be serviced. Other keyboard assemblies use anywhere from fifty to one-hundred screws to secure the keyboard in the keyboard assembly. To service a faulty keyboard, a plurality of screws would be removed and replaced, which would be a time-consuming process that runs the risk of not only over torquing the screws but also cross-threading the screws.

The present disclosure provides a bracket that, in conjunction with the components described herein, releasably secures an electronic component (e.g., a keyboard for a laptop computer) to electronic component mounting deck (e.g., a keyboard mounting deck for a keyboard of a laptop computer). To accomplish this, the electronic component has openings through which a head of a fastener extending from the electronic component mounting deck pass completely through. The bracket has fastening surfaces that engage the fastener to seat the electronic component between the bracket and the electronic component mounting deck. In this way, when a failed keyboard needs to be replaced, the bracket is moved to release the fastener heads from the bracket, The bracket is then separated from the failed keyboard, which is then lifted away from the electronic component mounting deck to be replaced with a new keyboard in a reverse operation. Currently, the present disclosure is related to replacing a failed laptop keyboard but could also extend to other electronic components such as, for example, a touch pad on a laptop or keyboard.

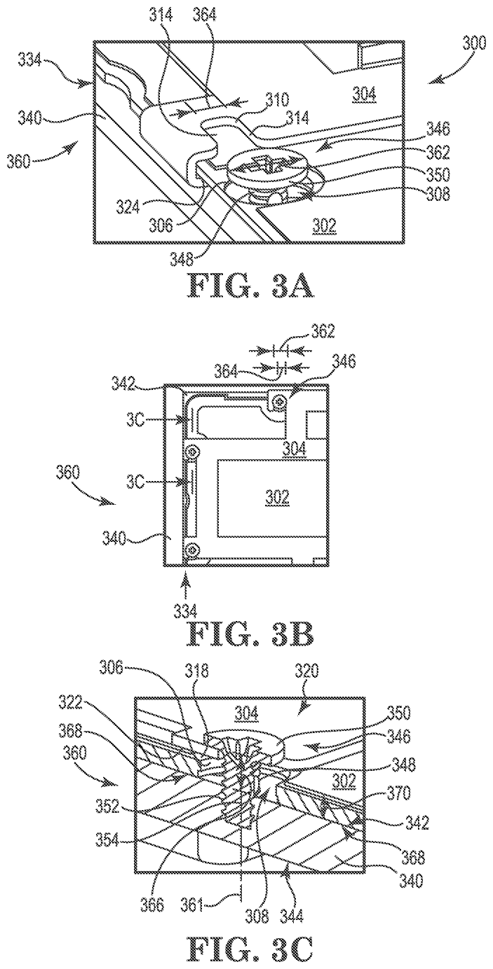

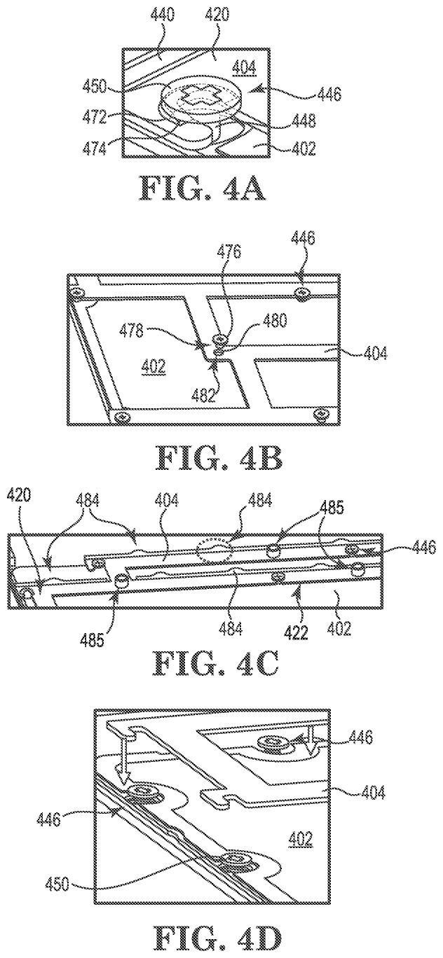

The figures herein follow a numbering convention in which the first digit or digits correspond to the drawing figure number and the remaining digits identify an element in the drawing. Similar elements between different figures may be identified by the use of similar digits. For example, 354 may reference element “54” in FIG. 3, and a similar element may be referenced as 454 in FIG. 4. It is emphasized that the purpose of the figures is to illustrate and the figures are not intended to be limiting in any way. The figures herein may not be to scale and relationships of elements in the figures may be exaggerated. The figures are employed to illustrate conceptual structures and methods herein described.

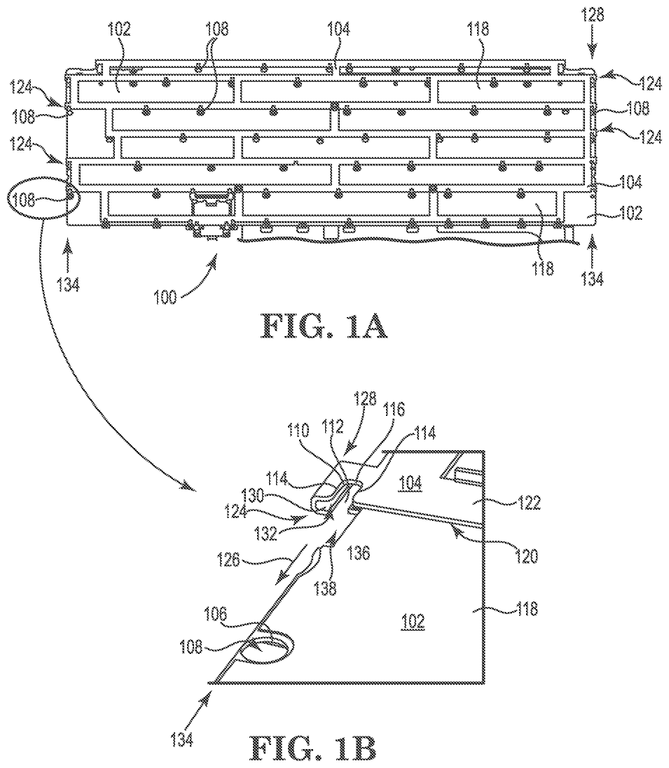

With reference to the figures, FIGS. 1A-1B illustrate a component assembly 100 for an electronic device, according to an example. As will be further described, the component assembly 100 includes an electronic component 102 and a bracket 104 that are used in conjunction with a fastener to seat the bracket 104 adjacent the electronic component 102. As an example, the component assembly 100 can be part of a keyboard assembly, where the electronic component 102 is a keyboard and the electronic device is, according to the example, a laptop computer.

FIGS. 1A-1B further illustrates the electronic component 102 having a fastener surface 106. As an example, the fastener surface 106 defines an opening 108 in the electronic component 102 through which a head of a fastener passes completely though. FIG. 1B further illustrates that the bracket 104 includes a fastening surface 110 defining a coupling recess 112 into which a portion of a shank of the fastener can be releasably positioned to seat the bracket 104 adjacent the electronic component 102. As will be further described and illustrated, an example in which a head of a fastener passes completely though the opening 108 to position a portion of a shank of the fastener relative the coupling recess 112 thereby allowing the bracket 104 to be seated adjacent the electronic component 102 is found below (e.g., FIGS. 3A-3C and associated discussion).

As illustrated in FIG. 1A, the electronic component 102 can have a plurality of the opening 108 (e.g., two or more of the opening 108). For example, FIG. 1A illustrates an example in which there are approximately forty (40) to fifty (50) of the opening 108. As illustrated, the plurality of the opening 108 in the electronic component 102 are spread across the surface area of the electronic component 102 to distribute the number and location at which the bracket 104 engages the fasteners that extend from the electronic component mounting deck though the openings 108 to help to seat the electronic component between the bracket 104 and the electronic component mounting deck (further illustrated in FIGS. 3A-3C below).

In the example illustrated in FIG. 1B, the fastener surface 106 provides a circular cross-sectional shape for the opening 108. Other cross-sectional shapes for the opening 108 are possible (e.g., oval, square, rectangular, among others). For the various examples, the cross-sectional shape of the opening 108 can be a function of the shape of the fastener head. Regardless of its cross-sectional shape, however, the opening 108 is designed to allow for the head of the fastener to pass through the opening 108. In the act of passing through the opening 108, the head of the fastener may come into contact with the fastener surface 106. But once through, the head of the fastener will be positioned above both the fastener surface 106 and the opening 108 of the electronic component 102. Once in this position, the bracket 104 can be moved (e.g., can slide) relative to the fastener to releasably position a portion of a shank of the fastener in the coupling recess 112 of the bracket 104 so as to seat the bracket 104 adjacent the electronic component 102.

The shape of the coupling recess 112 defined by the fastening surface 110 can also be a function of the fastener and in particular the shank of the fastener. As illustrated in FIG. 1B, the fastening surface 110 provides for a “U” shaped coupling recess 112 having two parallel surfaces 114 that provide a mirror image of each other and that each transition into a curved surface 116 that serves to couple the two parallel surfaces 114. This shape of the coupling recess 112 can receive a shank of a fastener having a circular cross-sectional shape (taken perpendicular to the long axis of the shank) such that a portion of the surface of the shank can be in contact with of the fastening surface 110. It is also possible that the surface of the shank does not touch or contact the fastening surface 110. The head of the fastener, however, is at least in contact with the bracket 104 to, as described herein, seat the bracket 104 adjacent the electronic component 102.

Regarding additional shapes for the coupling recess 112, these can include those in which the fastening surface 110 provides for a “V” shaped coupling recess 112 or in which the fastening surface 110 provides for a rectilinear polygonal opening, such as a “Π” shaped opening. Other shapes are possible.

As illustrated in the example of FIGS. 1A-1B, the electronic component 102 includes a first planar housing surface 118. As illustrated, the first planar housing surface 118 is a plane having a flat two-dimensional surface that is straight in two directions. For the example in which the electronic component 102 is a keyboard of a laptop computer, the first planar housing surface 118 illustrated in FIGS. 1A-1B is the side opposite of the keys of the keyboard (i.e., the back of the keyboard). Similarly, the bracket 104 include a first major surface 120 and a second major surface 122 opposite the first major surface 120, where each of the first major surface 120 and the second major surface 122 can each also be a flat two-dimensional surface that is straight in two directions (i.e., each provides a plane). Each of the first major surface 120 and the second major surface 122 can each also be substantially parallel. When the bracket 104 is seated adjacent the electronic component 102 the first planar housing surface 118 is parallel with the first major surface 120 of the bracket 104.

FIGS. 1A-1B further illustrate an example in which the bracket 104 includes a guide 124 that extends around a portion of the electronic component 102. For the various examples, the guide 124 allows the bracket 104 to slide laterally (along line 126) relative the electronic component 102 to position a portion of the shank of the fastener in the coupling recess 112 of the bracket (illustrated and discussed further with respect to FIGS. 3A-30 herein). The guide 124 also allows the bracket 104 to slide laterally relative the electronic component 102 to position a portion of the coupling recess 112 over the opening 108 (also illustrated and discussed further with respect to FIGS. 3B-3C herein). Bracket 104 can include a guide 124 or a plurality of guides on each lateral portion 128 of the bracket 104.

In the example, the guide 124 can include a surface 130 that turns back on itself in such a way as to provide a slot 132. The slot 132 can receive a lateral portion 134 of the electronic component 102 to position the bracket 104 and the electronic component 102 in such a way as to allow the bracket 104 to slide (along line 126) relative the electronic component 102, Coupling the guide 124 of the bracket 104 with the lateral portion 134 of the electronic component 102 can be accomplished in several ways. For example, the first major surface 120 of the bracket 104 can be positioned parallel with the first planar housing surface 118 of the electronic component 102 while aligning the slot 132 of the bracket 104 with a respective lateral side of the electronic component 102, after which the bracket 104 may slide into the desired position (e.g., to seat the electronic component 102 between the bracket 104 and the electronic component mounting deck, as discussed herein).

Alternatively, the electronic component 102 can include a first surface 136 that defines a recess 138 in the lateral portion 134 of the electronic component 102. The recess 138 can be shaped to receive a portion of the guide 124 helping to define the slot 132 and allowing the portion of the guide 124 to pass to allow the slot 132 to align with the lateral portion 134 of the electronic component 102. Once in this position, the bracket 104 can slide into the desired position (e.g., to seat the electronic component 102 between the bracket 104 and the electronic component mounting deck, as discussed herein).

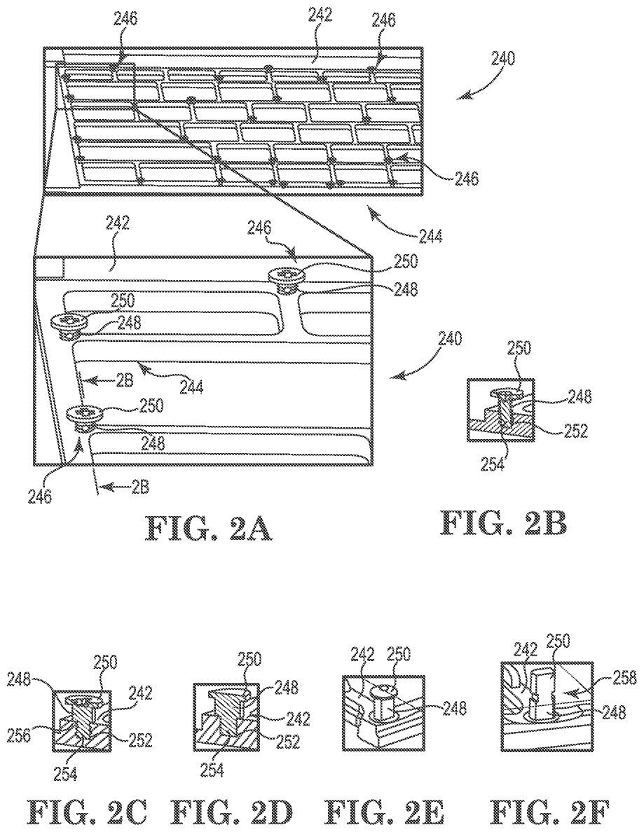

FIGS. 2A-2F illustrate an example of an electronic component mounting deck 240 (FIG. 2A) along with a fastener (FIGS. 2B-2F) for use in an electronic device. As discussed herein, the electronic device, according to an example, is a laptop computer, where an example of the electronic component mounting deck 240 is a keyboard mounting deck, which can also be referred to as a “C-deck” as are known in the art. The electronic component mounting deck 240 includes a first major surface 242 and a second major surface 244 opposite the first major surface 242. The electronic component mounting deck 240 includes a fastener 246 having a shank 248 and a head 250 that extends from the shank 248.

As illustrated, the fastener 246 is coupled to the electronic component mounting deck 240, where the head 250 on the shank 248 both extend in a common direction away from the first major surface 242 and the second major surface 244 of the electronic component mounting deck 240. In the present example, FIG. 2B illustrates the electronic component mounting deck 240 having a socket 252 in which a tail 254 of the fastener 246 is secured. As illustrated, the tail 254 and the shank 248 of the fastener 246 have threads (FIG. 2B), where the socket 252 can have corresponding threads that receive and engage the threads of the tail 254 thereby allowing the fastener 246 to be secured to the electronic component mounting deck 240.

In alternative examples, the shank 248 of the fastener 246 can have a smooth outer surface (e.g., no threads as seen in FIG. 2C), where the shank 248 includes a shoulder 256 that can seat against the first major surface 242 of the electronic component mounting deck 240 when the fastener 246 is coupled to the electronic component mounting deck 240. An example of such a fastener is seen in FIG. 2C. FIG. 2D provides another example of the fastener 246, where not only does the shank 248 of the fastener 246 have a smooth outer surface along with the shoulder 256, as discussed, but the tail 254 also has a smooth outer surface (e.g., no threads as seen in FIG. 2B). The socket 252 of the mounting deck 240 for the example in FIG. 2D is also correspondingly smooth. The tail 254 of the fastener 246 can be, among other techniques, mechanically (e.g., an interference fit or a press fit) and/or chemically (e.g., glued) secured in the socket 252 of the mounting deck 240.

In an alternative example, the fastener 246 can be a stake on which the head 250 is formed through either a thermal process (heat staking) or through mechanical techniques. For example, as illustrated in FIG. 2E, the fastener 246 is coupled to the electronic component mounting deck 240, where the head 250 is formed by thermally (e.g., melting a thermoplastic) and/or mechanically deforming a portion of the fastener 246 to form the head 250. Examples include, but are not limited to, the head 250 formed as a standard flared stake or a spherical stake, as are known in the art. FIG. 2F provides an example in which the fastener 246 includes a notch 258 into which the bracket can be positioned to seat the electronic component between the bracket and the electronic component mounting deck.

FIGS. 3A-3C provide an example of an electronic device 360 according to the present disclosure. The electronic device 360, as discussed herein, can be a laptop computer having the component assembly 300 with the electronic component 302 (e.g., a keyboard for the laptop computer) along with the electronic component mounting deck 340 (e.g., a keyboard mounting deck), as discussed herein. It is also appreciated that the electronic device 360 can also be a standalone keyboard peripheral.

As illustrated and as previously discussed, the electronic component mounting deck 340 includes the first major surface 342 and the second major surface 344 opposite the first major surface 342. The electronic component mounting deck 340 includes a socket 352 and the fastener 346 includes a tail 354 that is secured in the socket 352 of the electronic component mounting deck 340. The fastener 346 is coupled to the electronic component mounting deck 340, where the fastener 346 includes the head 350 on the shank 348 that both extend in a common direction away from the first major surface 342 and the second major surface 344 of the electronic component mounting deck 340, as previously discussed.

FIGS. 3A and 3C illustrate an example in which the electronic component 302 having the fastener surface 306 defines the opening 308 through which the head 350 of the fastener 346 passes completely through. The head 350 of the fastener 346 that passes completely through the opening 308 results in just the shank 348 of the fastener 346 being adjacent the electronic component 302 as taken perpendicularly along the longitudinal axis 361 of the fastener 346. As illustrated, the head 350 of the fastener 346 stands completely above (e.g., stands proud) both the first planar housing surface 318 and the second planar housing surface 368 of the electronic component 302. Also as illustrated, the fastener 346 does not touch the electronic component 302 when the bracket 304 is seated adjacent the electronic component 302 (illustrated in FIG. 30, among other places). In other words, neither the head 350 nor the shank 348 of the fastener 346 touches the electronic component 302 when the bracket 304 is seated adjacent the electronic component 302. This contrasts with the previous manners in which fasteners are used to secure the keyboard in the keyboard assembly, where the heads of the fifty to one-hundred screws or rivets contact and seat directly against the keyboard to secure the keyboard in the keyboard assembly.

The bracket 304 includes the fastener surface 306 that defines the coupling recess 312 into which a portion of the shank 348 of the fastener 346 can be releasably positioned to seat the electronic component 302 between the bracket 304 and the electronic component mounting deck 340. As illustrated, the head 350 of the fastener has a lateral dimension 362 that is larger than a width 364 of the coupling recess taken perpendicularly to the parallel surfaces 314 so that the head 350 contacts the bracket 304 when the electronic component 302 is seated between the bracket 304 and the electronic component mounting deck 340.

FIGS. 3A and 3B illustrate an example in which the bracket 304 further includes the guide 324 that extends around a portion of the electronic component 302. As illustrated in FIG. 3A, the guide 324 is poisoned over the lateral portion 334 of the of the electronic component 302. As seen in FIGS. 3B and 3C, the guide 324 allows the bracket 304 to slide laterally relative the electronic component 302 to position a portion of the coupling recess 312 over the opening 308. The bracket 304, as seen in FIG. 3A, slides relative to the fastener 346, with aid from guide 324, such that a portion of the shank 348 of the fastener 346 is releasably positioned in the coupling recess 312 to seat the electronic component 302 between the bracket 304 and the electronic component mounting deck 340.

FIGS. 3B and 3C provide an example of the electronic component 302 being seated between the bracket 304 and the electronic component mounting deck 340. Seating of the electronic component 302 between the bracket 304 and the electronic component mounting deck 340 is a result of an interference fit that can be seated or unseated as desired. Such an interference fit can be accomplished, among other ways, by having a longitudinal length 366 of the shank 348, taken along the longitudinal axis 361, that extends from the first major surface 342 of the mounting deck 340 to the head 350 of the fastener 346 (taken perpendicular to the first major surface 342) be anywhere from 0.5 to 10 percent less than a sum of (a) the thickness between the first major surface 320 and the second major surface 322 of the bracket 304 (taken perpendicular to the respective surfaces) and (b) a thickness 370 between the first planar housing surface 318 and a second planar housing 368 surface at the lateral portion 328 of the electronic component 302 (taken perpendicular to the respective surfaces).

FIGS. 4A-4D provide additional examples for the bracket 404 as provided herein. FIG. 4A provides an example in which, for the electronic device, the bracket 404 further includes a collar flange 472 that extends from the first major surface 420 of the bracket 404. As illustrated, the collar flange 472 can include a sloped surface 474 that can receive the head 450 of the fastener 446 as the bracket 404 is being slid into place. The remainder of the collar flange 472 can then contact the head 450 of the fastener 446 when the bracket 404 is seated adjacent the electronic component 402.

FIG. 4B provides an example of a releasable fastener 476 that can releasably join just the electronic component 402 (e.g., only the electronic component 402, etc.) and the bracket 404. The releasable fastener 476 can be a set screw the shank 478 of which passes through an opening 480 in the bracket 404 to engage a threaded socket 482 in the electronic component 402. The releasable fastener 476 can be used to releasably secure the bracket 404 to the electronic component 402 upon seating the bracket 404 adjacent the electronic component 402.

FIG. 4C provides an example of the bracket 404 that further includes a support member 484 that extends laterally away from both the first major surface 420 and the second major surface 422 of the bracket 404. The support member 484 can act as spacers for components that are positioned adjacent the bracket in the electronic device (e.g., the laptop computer),

FIG. 40 provides an example of the bracket 404, as discussed herein, except that it does not include the guide.

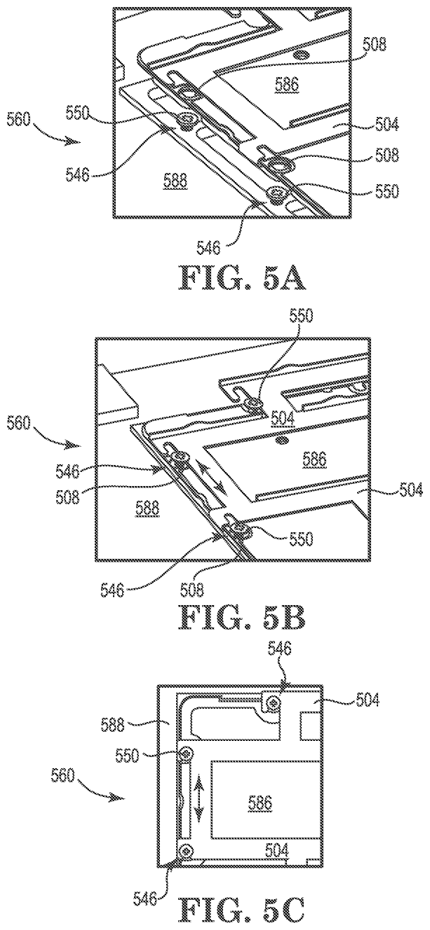

FIGS. 5A-5C provide an additional example of an electronic device 560. The electronic device 560 includes a keyboard 586 for a laptop computer. As discussed herein, the keyboard 586 is an example of the electronic component (e.g., electronic component 102 and 302) discussed herein, where the discussion and illustration of the electronic component 102 and 302 herein is applicable to the keyboard 586. The electronic device 560 further includes a keyboard mounting deck 588 having the fastener 546 with the head 550. As discussed herein, the keyboard mounting deck 588 is an example of the electronic component mounting deck (e.g., electronic component mounting deck 240 and 340) discussed herein, where the discussion and illustration of the electronic component mounting deck 240 and 340 herein is applicable to the keyboard mounting deck 588. The details of the fastener 546 and the head 550 are also as discussed and illustrated herein.

The electronic device 560 includes the bracket 504, the details of which are discussed and illustrated herein. The bracket 504 can move relative to the fastener 546 (represented by the double headed arrow), where the bracket 504 and the keyboard mounting deck 588 hold the keyboard 586 of the laptop in a predefined relative position (e.g., a seated position). As discussed herein, the bracket 504 can be moved relative the fastener 546 to seat or unseat the keyboard 586 from the keyboard mounting deck 588. Once unseated, the head 550 of the fastener 546 can pass through the opening 508 in the keyboard 586 of the laptop computer to move the keyboard 586 of the laptop computer relative the keyboard mounting deck 588.

FIG. 5A illustrates an example in which the keyboard 586 is unseated from the keyboard mounting deck 588. This would be the case when the keyboard 586 is being replaced. In unseating the keyboard 586 from the keyboard mounting deck 588, the bracket 504 is moved relative the fastener 546 to release the coupling recess 512 of the bracket 504 from the fastener 546 to expose the entire opening 508 of the keyboard 586 to the head 550 of the fastener 546. Once fully exposed, the keyboard 586 is removed from the keyboard mounting deck 588 by passing the head 550 of the fastener 546 through the opening 508 in the keyboard 586 of the laptop computer.

Seating the keyboard 586 happens by reversing the above actions to unseat the keyboard 586. In seating the keyboard 586, the keyboard 586 is moved relative to the keyboard mounting deck 588 and the fastener 546 to pass the head 550 of the fastener 546 through the opening 508 in the keyboard 586 of the laptop computer. FIG. 5B illustrates an example of this scenario. The bracket 504 is then moved relative the fastener 546 and the keyboard mounting deck 588 to seat the keyboard 586 between the bracket 504 and the keyboard mounting deck 588. FIG. illustrates an example of this scenario.

The bracket and the fastener of the present disclosure can be made of a number of different materials. For example, the bracket and the fastener can be made of a metal or metal alloy. Non-limiting examples of such a metal or metal alloy include stainless steel, aluminum, and aluminum alloys. The bracket and the fastener can also be made from a polymer, such as a thermoplastic polymer or a thermoset polymer, as are known in the art. Examples of such polymers include, but are not limited to, polycarbonate and acrylonitrile butadiene styrene, among others. Physical processes for forming either the bracket and/or the fastener can include, depending on the material, metal stamping and/or computer numerical control machining for the metal or metal alloy and injection molding techniques for the thermoplastic and thermoset polymers.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A component assembly for an electronic device, comprising:
an electronic component having a fastener surface defining an opening through which a head of a fastener passes completely through; and
a bracket having a fastening surface defining a coupling recess into which a portion of a shank of the fastener can be releasably positioned to seat the bracket adjacent the electronic component.

2. The component assembly of claim 1, wherein the electronic component includes a first planar housing surface and the bracket include a first major surface, wherein the first planar housing surface is parallel with the first major surface when the bracket is seated adjacent the electronic component,

3. The component assembly of claim 1, wherein the bracket further includes a collar flange that extends from a first major surface of the bracket to contact the head of the fastener when the bracket is seated adjacent the electronic component.

4. The component assembly of claim 1, wherein the bracket includes a guide that extends around a portion of the electronic component,

5. The component assembly of claim 4, wherein the guide allows the bracket to slide laterally relative the electronic component to position a portion of the shank of the fastener in the coupling recess of the bracket.

6. The component assembly of claim 4, wherein the guide allows the bracket to slide laterally relative the electronic component to position a portion of the coupling recess over the opening.

7. The component assembly of claim 1, wherein the bracket includes a first major surface and a second major surface opposite the first major surface, wherein the bracket further includes a support member that extends laterally the first major surface and the second major surface of the bracket, ay from both

8. The component assembly of claim 1, wherein the electronic component is a keyboard and the electronic device is a laptop computer.

9. An electronic device, comprising:
an electronic component mounting deck having a first major surface and a second major surface opposite the first major surface;
a fastener coupled to the electronic component mounting deck, wherein the fastener includes a head on a shank that both extend in a common direction away from the first major surface and the second major surface of the electronic component mounting deck;
an electronic component having a fastener surface defining an opening through which the head of the fastener passes completely through; and
a bracket having a fastening surface defining a coupling recess into which a portion of the shank of the fastener can be releasably positioned to seat the electronic component between the bracket and the electronic component mounting deck,

10. The electronic device of claim 9, wherein a fastener does not touch the electronic component when the bracket is seated adjacent the electronic component.

11. The electronic device of claim 9, wherein the bracket further includes a collar flange that extends from a first major surface of the bracket to contact the head of the fastener when the bracket is seated adjacent the electronic component.

12. The electronic device of claim 9, wherein the bracket includes a guide that extends around a portion of the electronic component.

13. The electronic device of claim 9, wherein the head of the fastener has a lateral dimension that is larger than a width of the coupling recess so that the head contacts the bracket when the electronic component is seated between the bracket and the electronic component mounting deck.

14. The electronic device of claim 9, wherein the electronic component mounting deck includes a socket and the fastener includes a tail that is secured in the socket of the electronic component mounting deck.

15. The electronic device of claim 9, wherein a releasable fastener releasably joins just the electronic component and the bracket.

16. The electronic device of claim 9, wherein the electronic component is a keyboard and the electronic device is a laptop computer.

17. An electronic device, comprising:
a keyboard for a laptop computer;
a keyboard mounting deck having a fastener with a head;
a bracket that moves relative to the fastener, wherein the bracket and the keyboard mounting deck hold the keyboard of the laptop computer in a predefined relative position, and wherein the head of the fastener passes through an opening in the keyboard of the laptop computer to move the keyboard of the laptop computer relative the keyboard mounting deck.

18. The electronic device of claim 17, further including unseating the keyboard from the keyboard mounting deck when moving the bracket relative to the fastener.

19. The electronic device of claim 17, further including removing the keyboard from the keyboard mounting deck when passing the head of the fastener through the opening in the keyboard of the laptop computer.

20. The electronic device of claim 17, wherein moving the bracket includes seating the bracket adjacent the keyboard.
